(19) United States
(12) Patent Application Publication
(10) Pub. No.: US 2016/0288785 A1
(43) Pub. Date: Oct. 6, 2016

(54) DRIVING SUPPORT SYSTEM FOR VEHICLE

(71) Applicant: FUJI JUKOGYO KABUSHIKI KAISHA, Tokyo (JP)

(72) Inventor: Shiro EZOE, Tokyo (JP)

(21) Appl. No.: 15/065,614

(22) Filed: Mar. 9, 2016

(30) Foreign Application Priority Data
Mar. 30, 2015 (JP) 2015-068383

(51) Int. Cl. B60W 30/045; B60W 40/072

(52) U.S. Cl. CPC B60W 30/045; B60W 40/072

(57) ABSTRACT

A driving support system for a vehicle that causes the vehicle to travel following a target travel route through steering and deceleration control includes: a target steering angle calculation unit that calculates a target steering angle at the time of passing through a curved section of the target travel route; a target deceleration calculation unit that calculates a target deceleration in the curved section; a deceleration correction value calculation unit that calculates, on the basis of the target steering angle and an actual steering angle, a corrected vehicle speed for correcting a target vehicle speed determined by the target deceleration; and a deceleration correction unit that corrects the target deceleration such that the target vehicle speed becomes the corrected vehicle speed.

### CROSS-REFERENCE TO RELATED APPLICATIONS

The present application claims priority from Japanese Patent Application No. 2015-068383 filed on Mar. 30, 2015, the entire contents of which are hereby incorporated by reference.

### BACKGROUND

1. Technical Field

The present invention relates to a driving support system for a vehicle that causes the vehicle to travel following a target travel route through steering control and deceleration control.

2. Related Art

In a vehicle such as an automobile, steering control and brake control are generally provided as mutually independent functions. For example, a problem arising when the vehicle makes a turn while decelerating is that a steering operation amount or brake operation amount required from the driver increases, thereby increasing an operation load on the driver.

Japanese Unexamined Patent Application Publication (JP-A) No. 2011-162004 discloses a technique by which, in order to resolve this problem, steering control or brake control is selected to be mainly performed, a main-side required value which is a required value of a vehicle turning motion to be performed is output to a main side on the basis of the selection result, and a non-main-side required value which is a required value corresponding to a difference between a target value and the main-side required value is output to a non-main side, thereby ensuring cooperative control of the steering control and brake control and reducing the operation load on the driver.

### SUMMARY OF THE INVENTION

However, the technique disclosed in JP-A No. 2011-162004 is concerned only with unique allocation of the required value of vehicle turning motion to steering control and deceleration control, and it cannot be said that the cooperation timing and degree of cooperation of the two controls are necessarily optimized.

For example, where the vehicle is driven along a curved target travel route, as depicted in FIG. 6, in the steering control, due the feedback correction component that compensates the response delay and control error, the control trajectory such as depicted by a broken line in the figure is actually realized, the behavior of the vehicle suspension system is disturbed, and the ride quality can be degraded. Even when the allocation of deceleration control is increased and the feedback correction component of steering control is uniquely decreased to avoid such a result, turn-back steering can occur and the accuracy of following the target travel route can be decreased.

It is desirable to provide a driving support system for a vehicle that can optimize cooperative control of steering control and deceleration control, and suppress the disturbance of the vehicle suspension system while ensuring the accuracy of following the target travel route.

An aspect of the present invention provides a driving support system for a vehicle that causes the vehicle to travel following a target travel route through steering control and deceleration control, the driving support system for a vehicle including: a target steering angle calculation unit that calculates a target steering angle at the time of passing through a curved section of the target travel route, as a target value such that a maximum steering angle is obtained at a circular-arc curve portion which continuously follows a transition curve portion of the curved section; a target deceleration calculation unit that calculates a target deceleration in the curved section as a deceleration at which a maximum lateral acceleration in the circular-arc curve portion is equal to or less than a set value; a deceleration correction value calculation unit that calculates, on the basis of the target steering angle and an actual steering angle, a corrected vehicle speed which is obtained by correcting the target vehicle speed determined by the target deceleration; and a deceleration correction unit that corrects the target deceleration such that the target vehicle speed becomes the corrected vehicle speed.

### BRIEF DESCRIPTION OF THE DRAWINGS

FIG. 1 is a configuration diagram of a driving support system for a vehicle;

FIG. 2 is an explanatory drawing illustrating the target travel route at the time of entering a curve;

FIG. 3 is an explanatory drawing illustrating the target steering angle and target deceleration at the time of entering a curve;

FIG. 4 is an explanatory drawing illustrating the correction of the target vehicle speed;

FIG. 5 is a flow chart of cornering control; and

FIG. 6 is an explanatory drawing illustrating the conventional control trajectory during cornering.

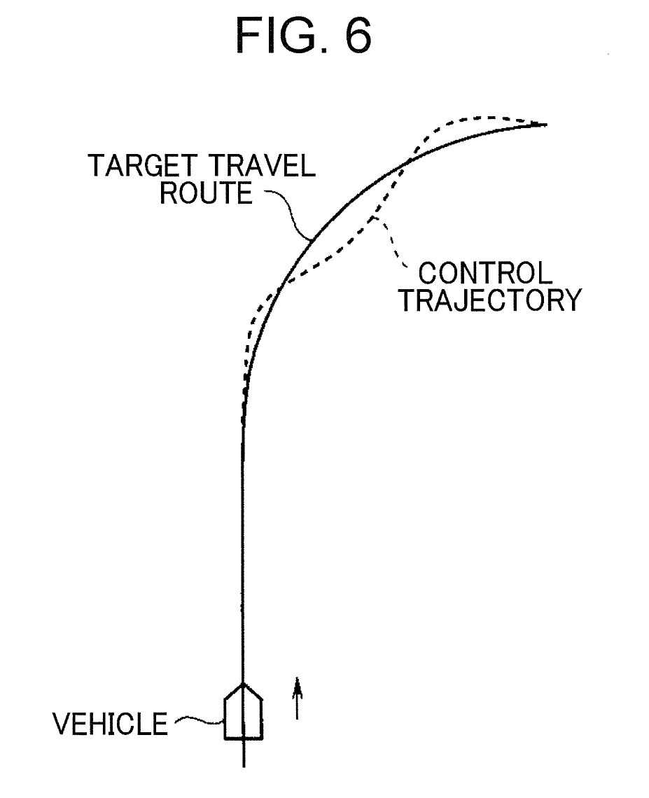

### DETAILED DESCRIPTION

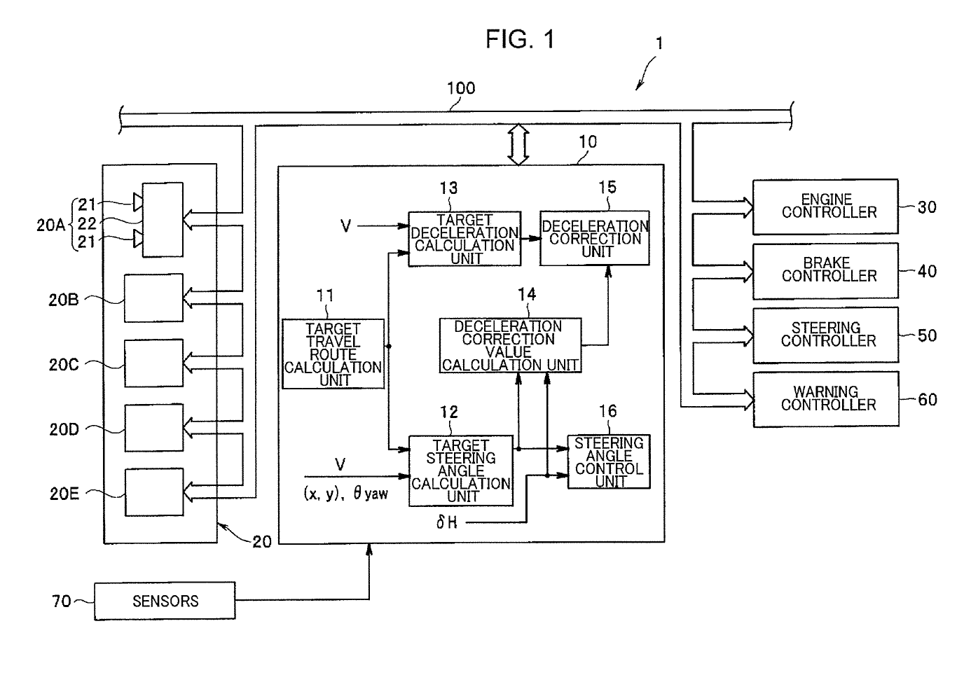

Implementations of the present invention will be described hereinbelow with reference to the drawings. In FIG. 1, the reference numeral 1 stands for a driving support system for a vehicle that executes driving support control including automatic drive based on external environment recognition results for the vehicle with respect to the driving operations of a driver. The driving support system 1 is centered on a travel controller 10 and configured by connecting an external environment monitor 20, an engine controller 30, a brake controller 40, a steering controller 50, a warning controller 60 and the like to an onboard network 100.

The external environment monitor 20 is configured by a combination of a group of devices that can autonomously recognize the external environment and a group of devices that acquire information through communication with the outside. The former group of devices includes a camera unit 20A that recognizes the external environment by processing captured images of the environment around the vehicle and a radar unit (laser radar, milliwave radar, ultrasound radar, and the like) 20B that receives reflected waves from three-dimensional objects present around the vehicle. The latter group of devices includes a vehicle position measuring unit 20C that measures the position (latitude, longitude, altitude) of the vehicle by using a global positioning system (GPS) or the like, a navigation unit 20D that is configured integrally with the vehicle position measuring unit 20C, performs route guidance by displaying the measured position of the vehicle on a map image, and outputs position coordinate data on the shape and branch points (intersections) of the road, data on the road type (highway, high-speed road, municipal road, etc.), and data relating to information on facilities present close to node points on the map, by using fine map data stored in the system, and a road traffic information communication unit 20E that acquires road traffic information by road-to-vehicle communication or vehicle-to-vehicle communication.

In the present implementation, the camera unit 20A is configured by integrating a stereo camera 21 and an image processing unit 22. The stereo camera 21 is constituted, for example, by a pair of left and right cameras using solid-state imaging elements such as CCD and CMOS. The pair of cameras is mounted at a predetermined distance from each other, for example, at the front side of the ceiling inside the vehicle cabin, captures the stereo image of an object outside the vehicle from different viewpoints, and outputs the captured image to the image processing unit 22.

The image processing unit 22 generates distance information on the basis of the triangular measurement principle from the displacement amount of the corresponding positions with respect to a pair of left and right images in front of the vehicle which have been captured by the pair of left and right stereo cameras 21. The external environment such as spatial objects, white lines on the road, and guard rails in front of the vehicle are recognized on the basis of the distance information, and the vehicle travel route is calculated on the basis of the recognized information. The image processing unit 22 also detects a preceding vehicle on the vehicle travel route on the basis of data on the recognized spatial object, calculates the distance between the vehicle and the preceding vehicle, the speed (relative speed) of the preceding vehicle relative to the vehicle, and the acceleration (deceleration) of the preceding vehicle, and outputs the calculation results as preceding vehicle information to the travel controller 10.

The engine controller 30 is a well-known controller that controls the operation state of the engine (not depicted in the figure) of the vehicle, for example, performs main control such as fuel injection control, ignition timing control, and opening degree control of an electronically controlled throttle valve on the basis of the intake air amount, throttle opening degree, engine water temperature, intake air temperature, air-fuel ratio, crank angle, accelerator depression amount, and other types of vehicle information.

A brake controller 40 is, for example, a well-known antilock brake system that can control brake devices of four wheels (not depicted in the figure) on the basis of a brake switch, speed of the four wheels, handle angle, yaw rate, and other types of vehicle information independently of the brake operation performed by the driver, or a well-known control device that performs yaw brake control or yaw momentum control of controlling the yaw momentum applied to the vehicle, such as skid preventing control. When a brake force of the wheels is input from the travel controller 10, the brake controller 40 calculates the brake hydraulic pressure for each wheel on the basis of the brake force and actuates a brake drive unit (not depicted in the figure).

A steering controller 50 is, for example, a well-known controller that controls an assist torque created by an electric power steering motor (not depicted in the figure) provided in the steering system of the vehicle on the basis of the vehicle speed, steering torque crated by the driver, handle angle, yaw rate, and other types of vehicle information. The steering controller 50 is also capable of lane departure prevention control of performing lane keep control by which the aforementioned travel lane is controlled to be maintained as a set lane and control preventing the departure of the vehicle from the travel layer. The steering angle or steering torque necessary for such lane keep control and lane departure prevention control are calculated by the travel controller 10 and input to the steering controller 50, and the electric power steering motor is drive controlled according to the input control amount.

The warning controller 60 generates, as appropriate, a warning when an abnormality occurs in various devices of the vehicle. For example, a warning or notification is issued by using at least one of a visual output, for example, with a monitor, a display, or an alarm lamp, and an audio output with a speaker or a buzzer. Further, when the driving support control is stopped by a driver's override operation, the driver is informed of the present operation state.

The travel controller 10 which is the principal component of the driving support system 1 having the above-described devices performs driving support control including automatic driving by cooperation of the cruise control including following travel, lane keep control, and lane departure prevention control on the basis of information from the devices 20, 30, 40, and 50 and the operation state information on the vehicle detected by a variety of sensors 70 such as a vehicle speed sensor, a steering angle sensor, a yaw rate sensor, and a lateral acceleration sensor. In particular, during cornering in automatic driving, the cooperative control of steering control and deceleration control is executed in an optimized form in order to suppress changes in the vehicle body behavior while maintaining the accuracy of following the target travel course.

For this purpose the travel controller 10 is provided, as depicted in FIG. 1, with a target travel route calculation unit 11, a target steering angle calculation unit 12, a target deceleration calculation unit 13, a deceleration correction value calculation unit 14, a deceleration correction unit 15, and a steering angle control unit 16 as cooperative control functions of steering and deceleration in cornering. The cooperative control of steering and deceleration with those functional units optimizes the yaw control by the brakes and suppresses the hunting caused by response delay or error in the yaw control caused by steering. With such control, by setting optimally the deceleration timing and the amount of deceleration at the time of entering the curve, the feedback correction fraction of the steering control is reduced without causing the turn-back steering, thereby suppressing the distortion of the vehicle suspension system while maintaining the accuracy of following the target travel route.

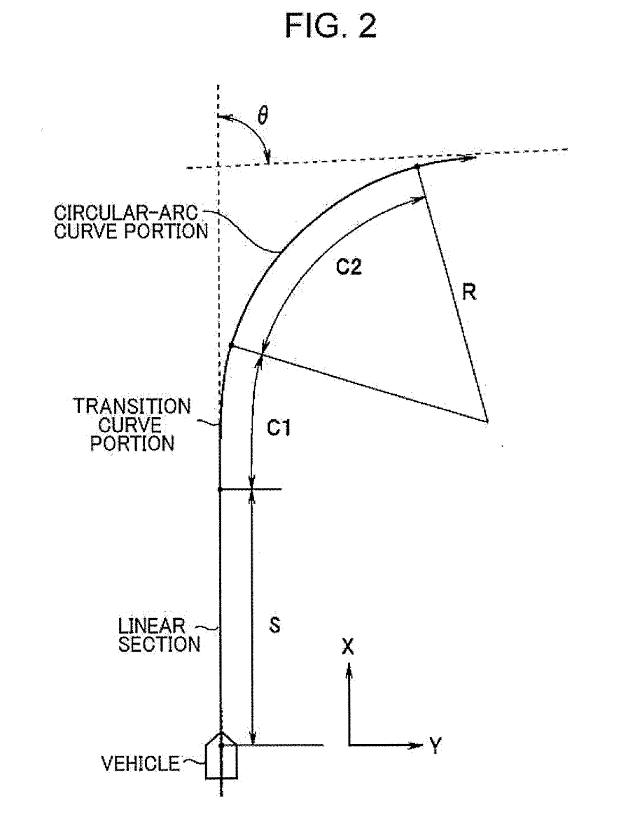

More specifically, the target travel route calculation unit 11 calculates the target travel route of the vehicle on the basis of the position information (latitude, longitude) of the vehicle which has been acquired from the external environment monitor 20, positions (latitude, longitude) of the node points on the map data constituting the traveling route, linear segments of the road, data on the curved segment (transition curve portion, circular-arc curve portion), and data on while lines on the road. The target travel route of the vehicle in cornering is set, for example, as depicted in FIG. 2, as a path in which the linear section S is connected to the circular-arc curve portion C2 with a constant curve radius R by the transition curve portion C1 at a curve depth (crossing angle) θ. In a vehicle coordinate system in which the position of the center of gravity of the vehicle is taken as a point of origin, and the front side of the vehicle is taken as an X axis and the lateral direction of the vehicle is taken as an Y axis, the target travel route is calculated as a curve passing through the center of the travel lane of the vehicle recognized from the road shape data and white line data.

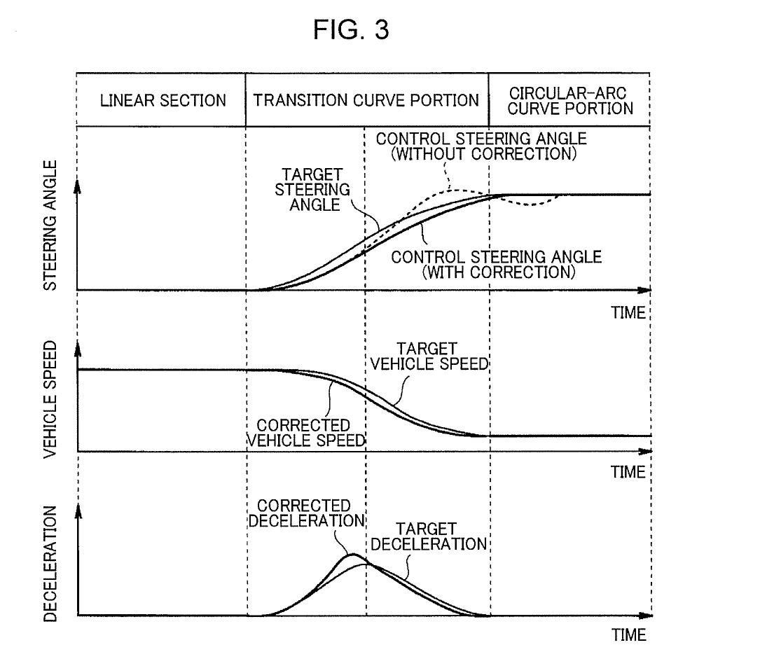

The target steering angle calculation unit 12 calculates a target steering angle δref for traveling along the target travel route on the basis of, for example, the speed V of the vehicle, vehicle position (x, y), and yaw angle θaw with respect to the target travel route, and outputs the calculated target steering angle to the deceleration correction value calculation unit 14 and the steering angle control unit 16. The target steering angle δref in the curved section includes a target steering angle δref_c1 in the transition curve portion and a target steering angle δref_r in the circular-arc curve portion and is calculated, as depicted in FIG. 3, as a target value such that a steering angle waveform in the transition curve portion C1 converges to a maximum steering angle δmax determined from the curve radius (minimum radius) R in the circular-arc curve portion C2 and the vehicle specifications.

Here, the target steering angle δref_c1 in the transition curve portion C1 is calculated as a target value at which the lateral acceleration (lateral jerk: d³y/dx³) of the vehicle is at a minimum. For example, a function J(x) is used which is obtained by taking a derivative of a polynomial relating to the jerk minimum curve, as indicated by Expression (1) hereinbelow, and the target steering angle is determined as a waveform that minimizes the value of the function J(x). In the Expression (1), A and B are adjustment parameters relating to the curve shape.

J(x)=30·(x/A)⁴−60·(x/A)³+30·(x/A)²·B/A² (1)

On the basis of the target travel route (X, Y, R), the target deceleration calculation unit 13 calculates, as a target deceleration Dref, the deceleration at which the maximum lateral acceleration at the curve radius (minimum radius) R is equal to or less than a set value (for example, 0.2G). As depicted in FIG. 3, the target deceleration Dref is a deceleration enabling the vehicle to decelerate to the target vehicle speed Vref in the section of the transition curve portion C1 and travel at a constant speed in the circular-arc curve portion C2.

The deceleration correction value calculation unit 14 calculates a correction value for correcting the target deceleration Dref on the basis of the target steering angle δref calculated by the target steering angle calculation unit 12 and an actual steering angle δH detected by a steering angle sensor. The correction value is a vehicle speed correction value for increasing or decreasing the target deceleration Dref correspondingly to the difference between the target steering angle δref and the actual steering angle δH, and calculated as a corrected vehicle speed (target vehicle speed after correction) Vref2 at which the same turning curvature as the turning curvature at the target steering angle δref and the target vehicle speed Vref is obtained at the actual steering angle δH. Then, the target deceleration Dref is corrected by the deceleration correction unit 15 such that the target vehicle speed Vref determined by the present target deceleration Dref becomes the corrected vehicle speed Vref2.

Thus, the feedback component of the steering angle control which is based on the difference between the target steering angle δref and the actual steering angle δH is reduced, without generating a turn-back steering, by adjusting the deceleration at the optimum timing and increasing or decreasing the yaw momentum, which is created by brakes, in response to the deviation from the target travel route. As a result, hunting can be prevented and the disturbance of the vehicle suspension system can be suppressed while ensuring the accuracy of following the target travel route.

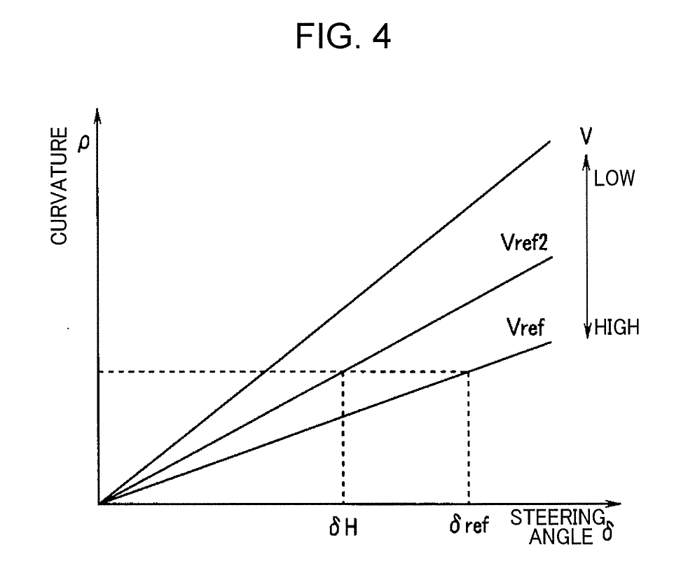

More specifically, for example, as depicted in FIG. 4, the relationship between the steering angle δ, curvature ρ, and vehicle speed V is mapped in advance, and the created correction map is referred to on the basis of the target steering angle δref and the present actual steering angle δH. FIG. 4 illustrates the case in which the actual steering angle δH is less than the target steering angle δref. In this case, the vehicle speed at the actual steering angle δH at which a curvature that is equal to the turning curvature at the target steering angle δref and the target vehicle speed Vref is obtained is determined as a corrected vehicle speed Vref2 on the lower speed side, and the target deceleration Dref is increased such that the present target vehicle speed Vref becomes the corrected vehicle speed Vref2 which is a low speed.

Conversely, when the actual steering angle δH has exceeded the target steering angle δref and became too large due to a road cant, or the like, the corrected vehicle speed Vref2 is determined as a vehicle speed higher than the target vehicle speed Vref, and the target deceleration Dref is reduced such that the present target vehicle speed Vref becomes the corrected vehicle speed Vref2 which is a high speed. Thus, where the actual steering angle δH deviates from the target steering angle δref, the target deceleration Dref is increased or decreased accordingly and the deviation of the target steering angle δH from the target steering angle δref is compensated.

The correction map for determining the corrected vehicle speed Vref2 can be created by the two-wheel model of cornering with a steady radius which is used when the curvature in the transition curve portion changes linearly for each constant position, or by matching which uses the actual vehicle. Expression (2) hereinbelow represents the relationship between the steering angle δ and curvature ρ obtained with the two-wheel model. The corrected vehicle speed Vref2 resulting in a constant curvature can be determined with the correction map created by using those relationships.

δ=(1/R)·(L−M·V²·(Lf·Kr−Lr·Kr)/(2·Kf·L)=ρ·(L+Ast−V²) (2)

where

Ast=−M·(Lf·Kr−Lr·KR)/(2·Kf·Kr·L);

Kf: cornering power of the front wheel;

Kr: cornering power of the rear wheel;

Lf: distance between the center of gravity and the front wheel;

Lr: distance between the center of gravity and the rear wheel;

L: wheelbase (Lf+Lr); and

M: vehicle mass.

The deceleration correction unit 15 corrects the target deceleration Dref such that the target vehicle speed Vref becomes the corrected vehicle speed Vref2 after a preset time Td. Where the preset time Td is long, the effect of the deceleration correction is weak, and where the preset time Td is short, the feel of deceleration provided to the driver or the pitching change feel is intensified and the driving feeling is degraded. Therefore, the preset time is set optimally by matching which uses the actual vehicle.

The steering angle control unit 16 calculates the target steering torque on the basis of the difference between the target steering angle δref and the actual steering angle δH and controls the electric power steering motor through the steering controller 50. Such control of the target torque is specifically executed as current control of the electric power steering motor through the steering controller 50. For example, the electric power steering motor is driven by a drive current IM represented by Expression (3) hereinbelow which is based on PID control.

I=Kv·(Kp·(δref−δH)+Ki·∫(δref−δH)dt+Kd·d(δref−δJ)/dt+Kf/R) (3)

where

Kv: motor voltage-current conversion factor;

Kp: proportional gain:

Ki: integral gain;

Kd: differential gain: and

Kf: feed-forward gain with respect to cornering.

In this case, the feedback correction component in the steering angle control is substantially reduced by adjusting the yaw brake by the correction of the target deceleration Dref implemented in parallel with the steering angle control. As a result, the vehicle can be caused to follow accurately the target travel route, while suppressing the disturbance of the vehicle suspension system caused by changes in the feedback correction.

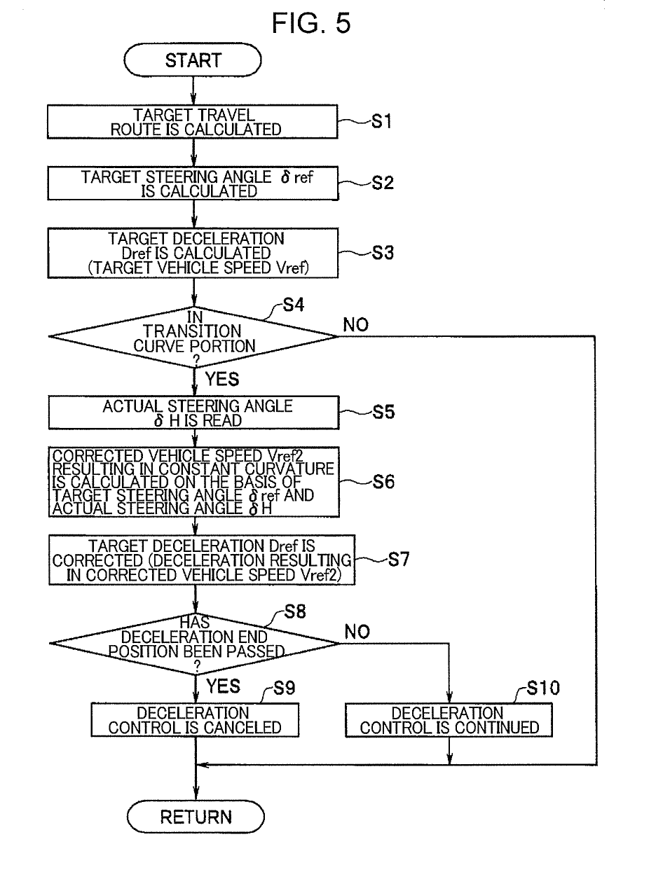

The program processing of cornering control performed by the travel controller 10 will be explained hereinbelow by using the flowchart depicted in FIG. 5.

In the cornering control, in the initial step S1, the shape data on the curve in front of the vehicle (depth of the curve, curve minimum radius, clothoid parameter, road width, white line shape, etc.) are acquired from the forward recognition information from the camera unit 20A and map information from the navigation unit 20D, and the target travel route of the vehicle is calculated on the basis of those data.

The processing then advances to step S2, and the target steering angle δref in the curve section is calculated. The target steering angle δref is a target value providing a waveform such that the lateral jerk is minimized in the transition curve portion and a maximum steering angle δmax determined by the curve radius R and vehicle specifications is obtained in the circular-arc curve portion (see FIG. 3).

Then, in step S3, the target deceleration Dref at which the vehicle is decelerated to the target vehicle speed Vref is calculated. The target deceleration Dref is a target value such that the lateral acceleration in the circular-arc curve portion that continuously follows the transition curve portion of the curved section is equal to or less than a predetermined constant value (for example, 0.2G).

The processing then advances to step S4, and it is investigated whether or not the vehicle position has entered the transition curve portion of the curved section. Where the vehicle position has not yet entered the curve (transition curve portion), the routine is stopped, and where the vehicle position has entered the curve (transition curve portion), the processing advances to step S5.

In step S5, the actual steering angle δH detected by the steering angle sensor is read, and in step S6, the corrected vehicle speed Vref2 resulting in a constant curvature with respect to the target vehicle Vref is calculated by using, for example, the correction map (see FIG. 4) based on the target steering angle δref and the actual steering angle δH. Then, in step S7, the target deceleration Dref is corrected by increasing or decreasing, by a set amount, the present target deceleration Dref so as to obtain the corrected vehicle speed Vref2 after the passage of the set time Td. As a result of correcting the target deceleration Dref, the feedback correction component determined by the difference between the target steering angle δref and the actual steering angle δH in the transition curve portion is reduced.

The processing then advances to step S8, and it is determined whether or not a deceleration end portion connected to the circular-arc curve portion with the minimum curve radius from the transition curve portion has been passed. As a result, when the deceleration end portion has been passed, the processing advances to step S9, the deceleration control of cornering is canceled, and the output of the control signal (target brake hydraulic pressure) to the brake drive unit through the brake controller 40 is canceled. When the deceleration end position has not been passed, the processing advances to step S10, the deceleration control of cornering is continued, and the output of the control signal (target brake hydraulic pressure) to the brake drive unit is continued.

Thus, in the present implementation, by setting the optimum deceleration timing and deceleration when entering a curve, it is possible to reduce the feedback correction component of steering control, without generating a turn-back steering, and to suppress the disturbance of the vehicle suspension system while ensuring the accuracy of following the target travel path.

1. A driving support system for a vehicle that causes the vehicle to travel following a target travel route through steering control and deceleration control, the driving support system comprising:
a target steering angle calculation unit that calculates, as a target steering angle at the time of passing through a curved section of the target travel route, a target value that reaches a maximum steering angle at a circular-arc curve portion that continuously follows a transition curve portion of the curved section;
a target deceleration calculation unit that calculates a target deceleration in the curved section that causes a maximum lateral acceleration in the circular-arc curve portion to be equal to or less than a set value;
a deceleration correction value calculation unit that calculates, on the basis of the target steering angle and an actual steering angle, a corrected vehicle speed for correcting a target vehicle speed determined by the target deceleration; and
a deceleration correction unit that corrects the target deceleration such that the target vehicle speed becomes the corrected vehicle speed.

2. The driving support system for a vehicle according to claim 1, wherein the deceleration correction value calculation unit calculates, as the corrected vehicle speed, a vehicle speed at the actual steering angle that causes a curvature to be equal in value to a turning curvature at the target steering angle and the target vehicle speed.

3. The driving support system for a vehicle according to claim 1, wherein
the steering angle calculation unit calculates, as the target steering angle, a target value at which a lateral acceleration is minimized in the transition curve portion, the target value reaching the maximum steering angle in the circular-arc curve portion, and
the maximum steering angle is obtained based on a curve minimum radius and vehicle specifications.

4. The driving support system for a vehicle according to claim 2, wherein
the steering angle calculation unit calculates, as the target steering angle, a target value at which a lateral acceleration is minimized in the transition curve portion, the target value reaching the maximum steering angle in the circular-arc curve portion, and
the maximum steering angle is obtained based on a curve minimum radius and vehicle specifications.

5. The driving support system for a vehicle according to claim 1, wherein the deceleration correction unit corrects the target deceleration such that the target vehicle speed becomes the corrected vehicle speed after a set time.

6. The driving support system for a vehicle according to claim 2, wherein the deceleration correction unit corrects the target deceleration such that the target vehicle speed becomes the corrected vehicle speed after a set time.

7. The driving support system for a vehicle according to claim 3, wherein the deceleration correction unit corrects the target deceleration such that the target vehicle speed becomes the corrected vehicle speed after a set time.

8. The driving support system for a vehicle according to claim 4, wherein the deceleration correction unit corrects the target deceleration such that the target vehicle speed becomes the corrected vehicle speed after a set time.
